(19) United States
(12) Patent Application Publication
(10) Pub. No.: US 2009/0106429 A1
(43) Pub. Date: Apr. 23, 2009

(54) Collaborative music network

(76) Inventors: Matthew L Siegal, New York, NY (US); Daniel J Zaccagnino, New York, NY (US)

Correspondence Address: DAVID AND RAYMOND PATENT FIRM, 108 N. YNEZ AVE., SUITE 128, MONTEREY PARK, CA, 91754, US

(21) Appl. No.: 11/977,209

(22) Filed: Oct. 22, 2007

(51) Int. Cl. G06F 15/16

(52) U.S. Cl. 709/227

(57) ABSTRACT

A collaborative music network for collaboratively linking members with each other has a central control center which is adapted for a plurality of members accessing thereto through internet, and a communication center linked to the central control center for interactively networking the members with each other. The music network includes a session for the session-members to edit, mix and record the audio files in the session and save them in the session and the user's own hard drive. The session also provides a live platform for session-members to interact and perform music. Non-session members are able to work on the audio files in the session. The completed music works are played through the network music player and purchased through online music store. The music network also contains an Internet radio to broadcast the audio files selected from member profiles.

### BACKGROUND OF THE PRESENT INVENTION

1. Field of Invention

This invention is to provide a music network, and more particularly, a collaborative music network which is adapted to provide a platform for musical artists, music professionals and fans to explore creative possibilities of interactively making and discovering music with people all over the world.

2. Description of Related Arts

Music is an art form which enriches and can even dominate some people's lives. Music is a skill that many learn as a child. They may learn to play an instrument, learn to sing, or even learn to compose. Some are just fans of music. For many, whatever their foray into music, it is a hobby. For others it becomes a way to make their living, and often, regardless of how they are involved in music, it becomes their passion.

For musical artists, sometimes finding a group of musical artists to play together is preferable over playing solo. In addition, as technology has improved, musical artists were able to record their music, thereby allowing them to allow others to hear their music. In the past, in the days of records and tapes, musical artists might play a song, and then have it reviewed by other musical artists, or sound engineers. The musical artists or sound engineers might suggest changes to the music, or suggest adding instruments or adding voices to a base vocal arrangement, or a base melody. In the days of records and tapes, this was done by having individuals record a “track” of the song on tapes or records, these tracks would then physically be combined like adding instruments together in a live orchestra to create a cohesive sound in line with the artistic desires of the individual, or individuals creating and recording the song. Originally, these recordings were analog recordings.

As technology advanced, soon the music was recorded digitally, first on tapes, and then on compact discs. Whereas before tracks of tape had to be physically cut and spliced together, now, digital files could be combined in a computer. However, there were still limitations. Music files can be very large and require significant computer processing. While an MPEG-3 audio file may be only a few megabytes, AIFF and WAV music files can be 50 megabytes or more. In the past, musical artists recording together had two alternatives. First, they could arrange to all meet at a recording studio. Then, different musical artists would be sequestered in separate rooms where their voice or instruments would be recorded separately, sometimes playing at the same time, sometimes being recorded individually. Later on, the different digital tracks could then be combined by a sound engineer. The individuals could then listen to the combination of the tracks.

The more musical artists required for a session, the more difficult it would be to set up convenient times for everyone to meet at the recording studio. In particular, if individuals lived in different cities, or countries, their ability to collaborate is limited by distance and time, and their own schedules. Furthermore, they might be limited to certain regional styles of music. If someone in one region of the country wanted to add a style from another genre from another state, or country, there may be difficulties in finding someone nearby, or bringing someone in from another region, state or country. Time, money, and choices then play a part in the quality and creativity of the music.

Alternatively, the musical artists could each record their own track wherever they lived, then each could send a digital copy, by mail for example, to a recording studio where the different tracks would be combined. The difficulty with this approach is that because the tracks are completed in different parts of the country, more time was required to complete a recording, since the recording studio could not combine the tracks until it received each track from the musical artists participating, and then had to send copies out to the various musical artists for their individual critiques, or changes, and then the whole process would begin again as each musical artist made changes, if any.

With the advent of the Internet, the ability to record at different studios and sending recordings to a recording studio became less burdensome as files could now be sent by electronic mail to the recording studio. However, because of the high volume of data involved, the transmission, downloading, and saving of files also can take enormous amounts of time. Thus, mixing one song with several tracks could take hours. And any mixed or edited song is larger in size than each separate track, thereby requiring hours to resend the song out in the form of a music file to the musical artists to review, and also requiring the musical artists, who may or may not be computer literate, to download, save, and review each song.

Now, people can buy software that allows them to mix a song or edit a song on their own home computer, but this still does not solve the issue of requiring any collaborator to either be at the same location, or have to send a large, cumbersome file which the editor, or mixer would then have to download before using his editing program at home to mix or edit the song. This also does not address the issue of having a greater variety of musical artists to choose from if one is seeking collaboration for a song.

Lastly, because of the issue of time and location, in order for the musical artist to use the expertise of certain recording studio, or studio engineer, the musical artist must either (1) go to the location of the studio or engineer, or (2) send a copy of his musical piece by mail, delivery, or email to the studio or engineer and then wait until the studio or engineer has returned the revised song to him for review, which can be time consuming and delay the eventual release of a song.

### SUMMARY OF THE PRESENT INVENTION

A main object of the present invention is to provide a collaborative music network through the internet for musical artists, music professionals and fans to explore creative possibilities of making music, working creatively together, and discovering music, regardless of location.

Another object of the present invention is to allow the members of the collaborative music network to create one or more sessions to invite other members with the right skills to work together for a music project, wherein the members are able to edit, mix, exchange, and record at least one audio file in the session.

Another object of the present invention is to allow the members of the collaborative music network to create one or more sessions utilizing sessions to invite other members with the right skills to work together for a music project, wherein the members are able to edit, mix, exchange, and record at least one audio file in the session console or other session interface.

Another object of the present invention is to allow each member as an artist to upload an audio file created by the member through the internet and send invitation messages to other members as invitees to critique the audio file.

Another object of the present invention is to provide a real time editing process for the session members of said session console to perform real-time mixing and/or editing to the audio file, such that the session members are able to see, hear and work together, regardless of whether all session members are at one physical location or many locations.

Another object of the present invention is to provide a central location where audio files can be mixed, or edited in real time without having to wait for an extended period of time for the audio files to be combined, mixed or edited.

Another object of the present invention is to provide a searching step for finding members based on certain criteria, such as craft, instrument, genre, name and location, for example.

Another object of the present invention is to provide a live platform for the artist to perform live through the music network and the invited session members to play with the artist regardless of physical location.

Another object of the present invention is to allow each member to selectively disseminate the audio file to other members through the internet.

Another object of the present invention is to allow each member to selectively upload the completed music works to the online music store.

Accordingly, in order to accomplish the above objects, the present invention provides a method for creating a music network, comprising the following steps.

(1) Provide a central control center for a plurality of members accessing thereto through the Internet. Each of the members is able to create one or more sessions in the central control center, wherein each of the sessions contains a personal profile of the respective member.

(2) Allow each of the members as a session owner to upload an audio file created by the session owner in the respective session of the central control center through the Internet.

(3) Send an invitation message to other the members as invitees to review the audio file. Therefore, the members are able to explore creative possibilities of making music, working creatively together, and discovering music, regardless of location.

These and other objectives, features, and advantages of the present invention will become apparent from the following detailed description, the accompanying drawings, and the appended claims.

### BRIEF DESCRIPTION OF THE DRAWINGS

FIG. 1 is a schematic representation of the music network regarding membership, personal profile and session creation.

FIG. 2 is a schematic representation of the music network regarding the details of a session creation.

FIG. 3 is a schematic representation of the music network regarding the function of the session console.

FIG. 4 is a schematic representation of the music network regarding the music player, internet radio and online music store.

### DETAILED DESCRIPTION OF THE PREFERRED EMBODIMENT

In a preferred embodiment, the present invention provides a collaborative music network for musical artists, which comprises a central control center and a communication center linked to the central control center.

The central control center, which is adapted for a plurality of members accessing thereto through Internet, comprises a plurality of sessions created by the members respectively such that each of the members is a session owner of the respective session. Each of the sessions contains data and information of the session owner and session members as well as audio files.

The communication center is linked to said central control center for interactively networking the members with each other, wherein the communication center provides an invitation channel for the session owner inviting other members as session members to appraise the audio file.

The collaborative music network is created by the following steps.

(1) Provide the central control center for the members accessing thereto through the Internet, wherein each of the members is able to create one or more sessions in the central control center that the session contains a personal profile of the respective member.

(2) Allow each of the members as a session owner to upload an audio file created by the session owner in the respective session of the central control center through the Internet.

(3) Send an invitation message to other members as invitees to review the audio file.

According to the preferred embodiment, the collaborative music network enables the musical artist to sign up as the community member by providing personal information such as the artist's name, e-mail address, geographical location, role or involvement in the music industry (examples include “musician,” “producer,” and “engineer,” often generally referred to as the artist's “craft”), instrument abilities and genre . . . etc.

The present invention provides a registering system for the user to become the member which comprises the steps of:

(a) requesting each of the users to input a set of criteria on the music network through the Internet; and

(b) assigning a username and password for each of the users to become the member of the music network such that the member may access the central control center.

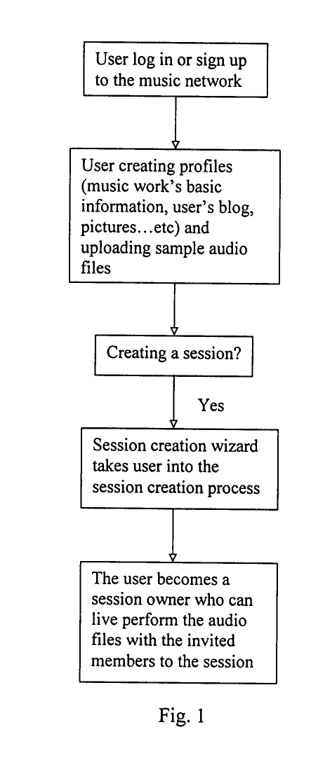

As illustrated in FIG. 1, the artist's profile is then edited by uploading the music works of the artist along with other related information to a website for storage on the website server. A blog can also be used by the artist to illustrate the background of the musical work, or to interact with other members, and give other members an opportunity to interact with other community members and comment on the artist and the music as well. A “talk back” feature not only allows session members to communicate with each other, but also allows non-members to comment on the session. The collaborative music network has a central location for each member called “My Studio” where the members may manage all projects and site activities, such as controlling the sale of your music, it's distribution to other sites on the internet, communication with other members, scheduling sessions, for example, and which displays active sessions, site usage data, messages, and contacts, for example.

The method of the present invention further comprises the following steps.

(a) Upload an audition audio file from the nonmember of the session for review by the session owner.

(b) Invite the nonmember by the session owner to become one of the members of the session based on the session owner's review of the audition audio file.

Accordingly, in order to send the invitation message from the session owner, the step (3) further comprises the following steps.

(3.1) Send a request containing a session need from the session owner to at least one of the invitees to mix and edit the audio file in response to the session need so as to fulfill a need of the session owner.

(3.2) Save an edited audio file in the session from the corresponding invitee, such that the session owner is able to review the edited audio file. The edited audio file from the invitee and the audio file from the session owner are saved in different names in the session.

When the artist wishes to cooperate with other member musical artists or professionals to create a music work, he or she can set up a session through a “session creation wizard” in which the artist becomes a session owner and discloses detailed information to achieve the goal of the music work, such as what type of instrument player is needed, genre, key, tempo . . . etc. The session owner can further upload a sample music file or audio file for the session members to listen to and to have more knowledge about the music work to be created. Furthermore, a live platform is provided for the session owner to perform the audio file on the Internet during the session, wherein the invitees are invited to play with the session owner during the session.

According to the preferred embodiment, the method of the present invention further comprises the following steps.

uploading of at least one edited audio file;

allowing a specific group of the session members to access the edited audio file; and

allowing the specific group of said session members to further mix or edit the edited audio files.

Accordingly, the audio file is defined as a core session audio file, wherein mixing and editing can only be done to the core session audio file.

The collaborative music network includes private and public sessions. The former are only visible and accessible to members of that session, and the latter can be viewed by all the members. However, only files designated by the session owner and/or member who uploaded the file can be downloaded by non-session members, and only the session owner or the member who uploaded a particular file has the authority to delete the file and perform other functions on it in the session.

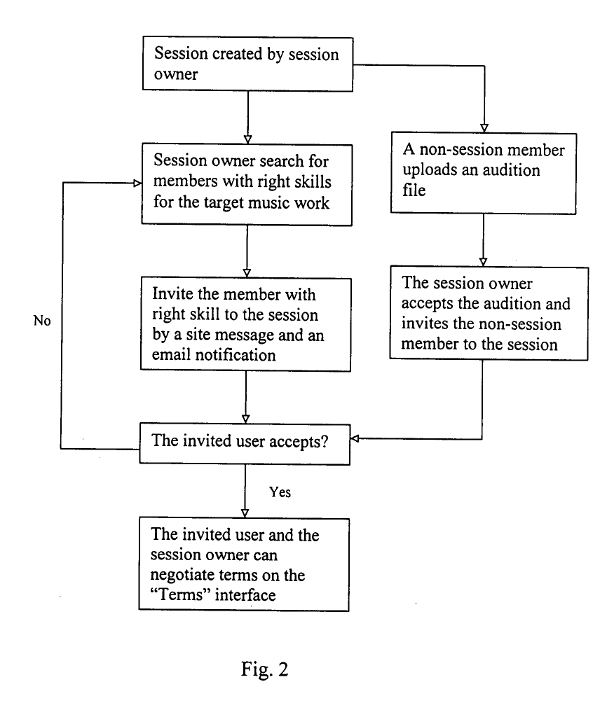

As can be seen in FIG. 2, the session owner as discussed above may search for members with necessary craft, instrument, genre, or even physical location, or other criteria. The collaborative music network of the present invention comprises a search engine for members searching the audio files throughout the collaborative music network, wherein the search engine contains a people search requiring query including at least one of craft, instrument, genre, member name and location for searching members in the central control center; and a session search requiring query including at least one of need, genre, and member name. Accordingly, each of the sessions further contains a session request requested from the session owner to each of the session members for mixing and editing the audio file in response to the session request so as to fulfill a need of the session owner. Once the session owner finds someone who fits the needs of the session, he or she can invite the member to the session which initiates an invitation process in which the system will send the invited member a site message and an e-mail notification which the invited member can accept or reject.

It is worth mention that the present invention, in the step (3.1), is adapted for providing suggestions of other members as recommended members who might fit the session need of the session, such that the session owner is able to invite one or more the recommended members to complete the session need of the session.

The invitation message should include a set of terms from the session owner to the members as invitees upon which the members as invitees must agree before the members as invitees may review the audio file.

Once the invited member accepts the invitation, a “terms” interface enables the invited user or session owner to propose terms which can be accepted or rejected by the receiving party. After both parties agree with the terms, the terms will appear for the applicable members to see and re-propose if they choose. In a preferred embodiment, the session members with “terms” can pay each other via some sort of payment system, such as the online payment system, PayPal, or other credit systems through this music network.

Additionally, a non-session member can also search for sessions in which he or she has an interest to participate. The non-session member can upload an audition file by clicking an “upload audition” button. A small window will pop up immediately and the non-session member is then asked to fill out some basic information about the uploaded file in the pop-up window. A copy of the uploaded audio file will be automatically converted to an MP3 file, with the original file retained on the system. The session owner will be notified by the music network system that someone has submitted an audition and the session owner can accept the audition and make the user who submitted the audition a member of the session.

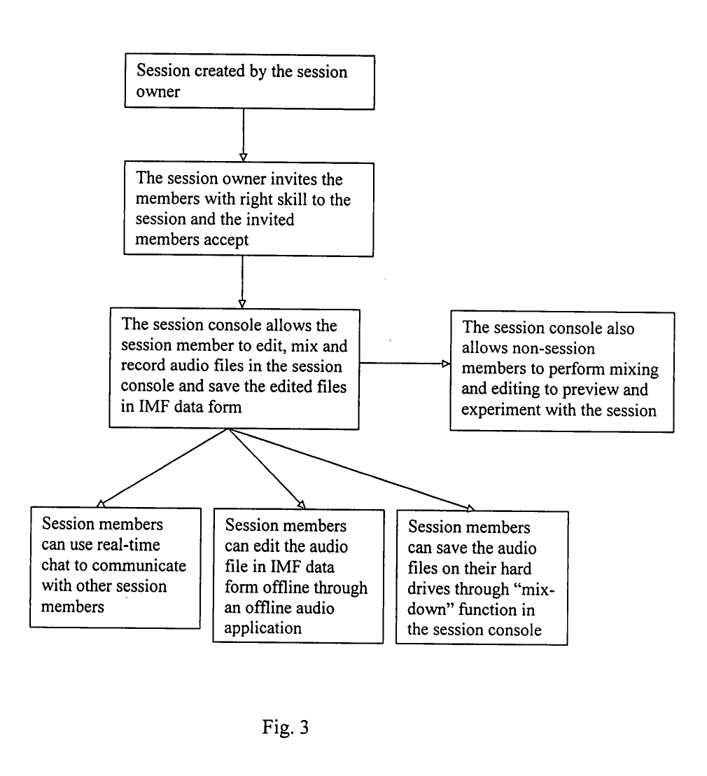

Referring to FIG. 3, the session member can access a session console through the Internet and is allowed to edit, mix and record audio files existing in the session console, which could include volume and pan on an individual track level, mute and solo, and volume tracking over time, cropping, looping, zoom, pitch manipulation, audio clip tempo manipulation, metronome, snap-to-grid, plug-in support, chromatic tuner, audio effects, importing and exporting to and from desktop software programs, midi sequencing, chat, video chat, video file support, etc. Detailed information of each audio file is provided in the session and in the session console and the session member can edit any region of an audio track by moving or deleting the track in the editing window.

One important task that can be completed during a session is that a session member can complete a “mixdown” through the session or in the session console. A “mixdown” is combining multiple audio files, edits, and settings (all audible aspects) into a single stereo audio file. Accordingly, the present invention provides a “mixdown” platform in which at least one of the session members can combine at least two of the edited audio files to create a combined edited audio file.

The music network also has an offline audio application which can run independently of the network without an internet connection. While the members cannot conduct mixing, recording and editing to the audio file through the Internet, these functions can be perfectly performed offline if the audio file has been downloaded to the hard drive. In other words, the offline audio application acts as an offline editing device. Although the audio file is edited offline, the file can still be uploaded to sessions after being edited. If an Internet connection is present, the audio application can be integrated with the online system to allow for direct uploading and downloading of audio files for in session editing or mixing, etc. Lastly, the offline audio application allows the session member to use more processor intensive features offline that would be harder to do with the online version.

According to the preferred embodiment, the member can select a format of the audio file in the session, wherein the step (2) further comprises the following steps.

(2.1) Select a format of the audio file in the session.

(2.2) Upload the audio file in according to the format.

(2.3) Create a preview file of the audio file for the members to download and/or listen.

The edited file can be saved in the session console in IMF (Indaba Music File), AAF (Advanced Authoring Format), MXF (Material Exchange Format), OMF (Open Media Framework), XML (Extensible Markup Language), or other data forms which are audio-file-specific data. In addition to the IMF data form, the edited file may also be saved in other file formats currently available for storing audio data. Also, the “mixdown” function enables the session member to save a mix in the session console (including all cropping, sliding, volume, volume over time, pan data and all other available edits for all the files in the mix) to a single MP3, AIFF, or WAV file on the member's hard drive. This function allows members to share and distribute the finished music products from the website. In addition, a real-time interactive window is provided for the session for the session members to communicate and exchange their ideas about the music work immediately. In other words, in the step (3.1), the session owner and the invitees communicate in real-time with each other through the respective session. Also, the session members can perform real-time mixing and/or editing so that every session member can see, hear and then edit the music together. Therefore, the present invention provides a real time exhibiting and editing process for the invitees to perform real-time mixing and/or editing of the audio file.

When the session members upload their audio files, they have the ability to set permissions for who can download the file. For example, they can choose that only they are allowed to access the file, they may also choose that they and the session owner are able to download the file, or that all session members are allowed to download the file. Additionally, the session owner can set certain files as core session audio files. A core session audio file is a main session file for members to work with. In public sessions, core session audio files are available for download even for non-session members. Members can give the owner permission to change a file they have uploaded to a core session audio file, but only files uploaded by the owner or designated in this way by a session member can be made core session audio files. All session files are converted into low bit-rate preview files to make loading time in the session console faster and download smaller and faster. High quality versions are kept for download and for use in mixdown.

The non-session member is allowed to preview and experiment with the audio files in the session and in the session console. In other words, the non-session member is allowed to perform mixing and/or editing of the audio files in the session and in the session console. However, the non-session member is not allowed to either save the edited file and/or mixes on the Collaborative music network or on his or her own hard drive.

All activities of a session can then be recorded via a recording platform so all participants in the session will have a record of the activities that occurred during the session and which of the members contributed any input to the mixing and/or editing of the audio files. The present invention further comprises a step of posting a rating of the audio file from each of the invitees after the invitee reviews the audio file.

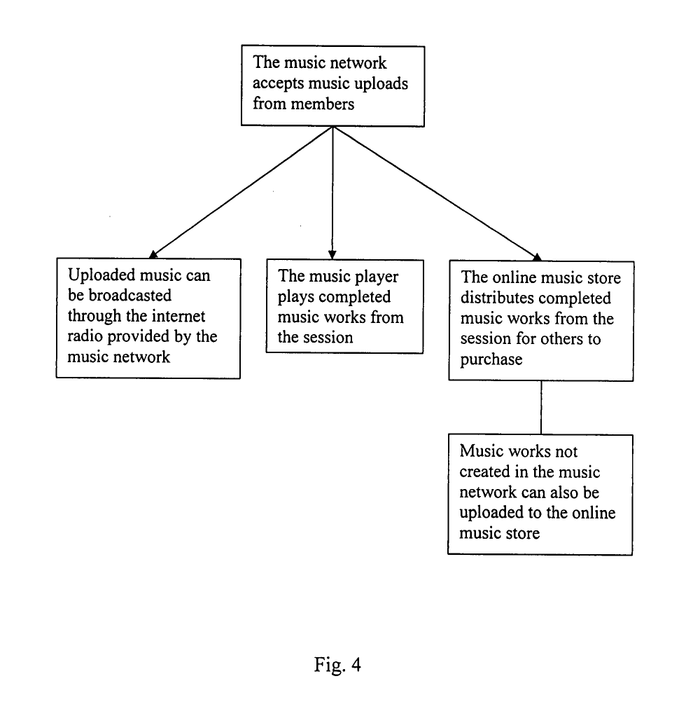

Referring to FIG. 4, a community member may upload music into the music network. The music can be broadcast through an internet radio provided through the music network. The music can also be played on a musical player on the music network through Internet. The music can also be uploaded to an online music store for sale and distribution. Therefore, the present invention further provides a buy option for the members and for a non-member to purchase the audio file. Alternatively, the buy option is provided for the members and for a non-member to purchase a set of rights to the audio file. Accordingly, the audio file is uploaded to a location where the audio file may be broadcast by an internet user, wherein the quantity of broadcasts of the audio file will be tracked.

The music that is uploaded can be one of the completed edited audio files from one of the sessions. The music can also be a musical work of the community member that was not created in the music network, or in one of the sessions, such as the original audio file that was later edited in a session or outside a session, or other audio files which were not part of any session.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for creating a music network, comprising the steps of:
(a) providing a central control center for a plurality of members accessing thereto through the Internet, wherein each of said members is able to create one or more sessions in said central control center that said session contains a personal profile of said respective member;
(b) allowing each of said members as a session owner to upload an audio file created by said session owner in said respective session of said central control center through the Internet; and
(c) sending an invitation message to other said members as invitees to review said audio file.

2. The method, as recited in claim 1, wherein the step (c) further comprises the steps of:
(c.1) sending a request containing a session need from said session owner to at least one of said invitees to mix and edit said audio file in response to said session need so as to fulfill a need of said session owner; and
(c.2) saving an edited audio file in said session from said corresponding invitee, such that said session owner is able to review said edited audio file, wherein said edited audio file from said invitee and said audio file from said session owner are saved in different names in said session.

3. The method, as recited in claim 2, wherein the step (c.1) further comprises a step of providing suggestions of other said members as recommended members who might fit said session need of said session, such that said session owner is able to invite one or more said recommended members to complete said session need of said session.

4. The method as recited in claim 1, wherein step (c) further comprises the steps of:
providing a set of terms from said session owner to said members as invitees upon which said members as invitees must agree before said members as invitees may review said audio file.

5. The method as recited in claim 2, wherein step (c) further comprises the step before (c.1) of:
(c.0) providing a set of terms from said session owner to said members as invitees upon which said members as invitees must agree before said members as invitees may review said audio file.

6. The method as recited in claim 3 wherein, in the step (c.1), said session owner and said invitees communicate in real-time with each other through said respective session.

7. The method as recited in claim 3, between the step (c.1) and the step (c.2), further comprising a step of real time exhibiting and editing process for said invitees to perform real-time mixing and/or editing of said audio file, such that said invitees are able to see, hear and work together.

8. The method as recited in claim 1, further comprising the following steps of:
editing said audio file by at least one of said members; and
combining at least two of said edited audio files to create a combined edited audio file by at least one of said members.

9. The method as recited in claim 2, between step (c.1) and step (c.2), further comprising the following step of:
combining at least two of said edited audio files to create a combined edited audio file by at least one of said members.

10. The method as recited in claim 3, between step (c.1) and step (c.2), further comprising the following step of:
combining at least two of said edited audio files to create a combined edited audio file by at least one of said members.

11. The method as recited in claim 6, between step (c.1) and step (c.2), further comprising the following step of:
combining at least two of said edited audio files to create a combined edited audio file by at least one of said members.

12. The method as recited in claim 7 further comprising, between the step (c.0) and the step (c.2), the following step of:
combining at least two of said edited audio file to create a combined edited audio file by at least one of said members.

13. The method, as recited in claim 1, further comprising a step of saving a record of any activity conducted by one or more of said members during said session.

14. The method as recited in claim 2, further comprising a step of saving a record of any activity conducted by one or more of said members during said session.

15. The method as recited in claim 7, further comprising a step of saving a record of any activity conducted by one or more of said members during said session.

16. The method as recited in claim 8, further comprising a step of saving a record of any activity conducted by one or more of said members during said session.

17. The method as recited in claim 12, further comprising a step of saving a record of any activity conducted by one or more of said members during said session.

18. The method, as recited in claim 1, wherein said session further comprises a session console for said members to access through Internet, wherein said member is able to edit, mix, and record said audio file through said session console.

19. The method as recited in claim 18, further comprising a step of saving a record of any activity conducted by one or more of said members during said session.

20. The method, as recited in claim 1, further comprising a step of posting a rating of said audio file from each of said invitees after said invitee reviews said audio file.

21. The method, as recited in claim 1, wherein the step (b) further comprises a step of selecting a format of said audio file in said session.

22. The method, as recited in claim 1, wherein the step (b) further comprises the steps of:
selecting a format of said audio file in said session,
uploading said audio file in according to said format, and
creating a preview file of said audio file for members to download and listen.

23. The method, as recited in claim 1, further comprising a searching step for said members to search by one of people search and session search.

24. The method, as recited in claim 23, wherein said people search requires query including at least one of craft, instrument, genre, member name and location for searching members; and said session search requires query including at least one of need, genre, and member name.

25. The method, as recited in claim 1, further comprising a searching step for said members to search by one of people search and session search, wherein said people search requires query including at least one of craft, instrument, genre, member name and location for searching members; and said session search requires query including at least one of need, genre, and member name.

26. The method, as recited in claim 1, further comprising a step of providing a live platform for said session owner to perform live on the Internet during said session, wherein said invitees are invited to play with said session owner during said session.

27. The method, as recited in claim 1, further comprises a step of selectively broadcasting said audio file uploaded by said session owner through the Internet.

28. The method, as recited in claim 1, further comprising a step of providing a buy option for said members and for a non-member to purchase said audio file.

29. The method, as recited in claim 1, further comprising a step of providing a buy option for said members and for a non-member to purchase a set of rights to said audio file.

30. The method, as recited in claim 29, further comprising the steps of:
uploading said audio file to a location where said audio file may be broadcast by an internet user; and
tracking the quantity of broadcasts of said audio file.

31. The method, as recited in claim 1, wherein the step (a) further comprises a step of selecting said session as one of a private session or a public session by said respective member, wherein when said session is selected as said private session, only said members selectively invited by said session owner are authorized to access said session and said audio file within said session, wherein when said session is selected as said public session, all said members may access said public session and said audio file.

32. The method as recited in claim 1 wherein, in the step (c), each of said invitees become a session member of said session and is authorized to download said audio file in said session.

33. The method, as recited in claim 1, further comprising the following steps:
uploading an audition audio file from a nonmember of said session for review by said session owner, and
inviting said nonmember by said session owner to become one of said members of session based on said session owner's review of said audition audio file.

34. The method, as recited in claim 2, further comprising the following steps:
uploading an audition audio file from a nonmember of said session for review by said session owner, and
inviting said nonmember by said session owner to become one of said members of session based on said session owner's review of said audition audio file.

35. The method, as recited in claim 1, further comprising a registering step before step (a) which comprises the steps of:
requesting each of users to input a set of criteria on said music network through the Internet; and
assigning a username and password for each of said users to become said member of said music network such that said member may access said central control center.

36. The method, as recited in claim 1, further comprising the step of allowing a specific group of said session members to access said audio file.

37. The method as recited in claim 1, further comprising the steps of:
uploading of at least one edited audio file;
allowing a specific group of said session members to access said edited audio file; and
allowing said specific group of said session members to further mix or edit said edited audio files.

38. The method, as recited in claim 36, further comprising the step of defining said audio file as a core session audio file.

39. The method, as recited in claim 38, wherein mixing and editing can only be done to said core session audio file.

40. The method, as recited in claim 37, further comprising the step of defining at least one of a group of session audio files consisting of said audio file and at least one of said edited audio files as a core session audio file.

41. The method, as recited in claim 40, wherein mixing or editing can only be done to said core session audio file.

42. A music network for collaboratively linking members with each other, comprising:
a central control center, which is adapted for a plurality of members accessing thereto through Internet, comprising a plurality of sessions created by said members respectively such that each of said members is a session owner of said respective session, wherein each of said sessions contains data and information of said session owner and session members as well as audio files; and
a communication center linked to said central control center for interactively networking said members with each other, wherein said communication center provides an invitation channel for said session owner inviting other said members as session members to appraise said audio file.

43. The collaborative music network, as recited in claim 42, wherein each of said sessions further contains a session request requested from said session owner to each of said session members for mixing and editing said audio file in response to said session request so as to fulfill a need of said session owner.

44. The collaborative music network, as recited in claim 42, further comprising a session console for said members to access through Internet, wherein said session console provides a mix-and-edit platform for said members to edit, mix, and record an edited audio file.

45. The collaborative music network, as recited in claim 42, further comprising a search engine for members searching said audio files throughout said collaborative music network, wherein said search engine contains a people search requiring query including at least one of craft, instrument, genre, member name and location for searching members in said central control center; and a session search requiring query including at least one of need, genre, and member name.

46. The collaborative music network, as recited in claim 42, further comprising a live platform for said session owner and said session members to perform live said audio file.

47. The collaborative music network, as recited in claim 43, further comprising a mixdown platform in which at least one of said session members can combine at least two of said edited audio files to create a combined edited audio file.

48. The collaborative music network, as recited in claim 44, further comprising a mixdown platform in which at least one of said member can combine at least two of said edited audio files to create a combined edited audio file.

49. The collaborative music network, as recited in claim 42, further comprising a recording platform for recording said session activity.

50. The collaborative music network, as recited in claim 43, further comprising a recording platform for recording said session activity.

51. The collaborative music network, as recited in claim 46, further comprising a recording platform for recording said session activity.

52. The collaborative music network, as recited in claim 47, further comprising a recording platform for recording said session activity.

53. The collaborative music network, as recited in claim 48, further comprising a recording platform for recording said session activity.

54. The collaborative music network, as recited in claim 44, further comprising a core session audio file from a group consisting of said audio file and at least one of said edited audio files.

55. The collaborative music network, as recited in claim 46, further comprising a core session audio file from a group consisting of said audio file and at least one of said edited audio files.

56. The collaborative music network, as recited in claim 47, further comprising a core session audio file from a group consisting of said audio file and at least one of said edited audio files.

57. The collaborative music network, as recited in claim 48, further comprising a core session audio file from a group consisting of said audio file and at least one of said edited audio files.

58. The collaborative music network, as recited in claim 42, further comprising a broadcasting channel for selectively broadcasting said audio file uploaded by said session owners through Internet.

59. The collaborative music network, as recited in claim 42, further comprising a music player for each of said members selectively playing said audio file through Internet.
